(19) United States
(12) Patent Application Publication
(10) Pub. No.: US 2009/0109091 A1
(43) Pub. Date: Apr. 30, 2009

(54) GLOBAL NAVIGATION SATELLITE SYSTEM RECEIVER AND METHOD OF OPERATION

(75) Inventors: Surinder THIND, Middlesex (GB); Paul Gomme, Middlesex (GB)

Correspondence Address: THE FARRELL LAW FIRM, P.C., 290 Broadhollow Road, Suite 210E, Melville, NY, 11747, US

(73) Assignee: Samsung Electronics Co., Ltd., Suwon-si (KR)

(21) Appl. No.: 12/257,897

(22) Filed: Oct. 24, 2008

(30) Foreign Application Priority Data
Oct. 24, 2007 (GB) 0720853.1

(51) Int. Cl. G01S 1/08

(52) U.S. Cl. 342/357.12

(57) ABSTRACT

A system and method of operating a Global Navigation Satellite System (GNSS) receiver is disclosed, by receiving a plurality of navigation signals, operating the receiver in a first mode and operating the receiver in a second mode, each of the first navigation signals is a signal transmitted from a respective space vehicle and includes a respective sequence of navigation messages, each navigation message includes data indicative of at least a position of the respective space vehicle.

### PRIORITY

This application claims priority under 35 U.S.C. §119(a) of an application entitled “Global Navigation Satellite System Receiver and Method of Operation” filed in the United Kingdom Intellectual Property Office on Oct. 24, 2007 and assigned Serial No. 0720853.1, the contents of which are hereby incorporated by reference.

### BACKGROUND OF THE INVENTION

1. Field of the Invention

The present invention relates to receivers for global navigation satellite systems, and in particular to receivers adapted to receive signals from navigation satellites (i.e. space vehicles (SVs)) and to determine a position of the receiver from those received signals.

2. Description of the Related Art

There are a number of known global navigation satellite systems, including the Global Positioning System (GPS), also known as NAVSTAR GPS and at present the only fully functioning system, GLObal NAvigation Satellite System (GLONASS), and the Galileo positioning system. In these systems, a constellation of orbiting satellites (also known as Space Vehicles (SVs)) transmits navigation signals, and terrestrial receivers are able to receive these signals and calculate a position from the received signals. The present invention is applicable to receivers for these known systems, and for any future systems which may be developed, again involving the transmission of navigation signals from a plurality of space vehicles.

As further background, some additional information on GPS systems will now be presented, although it should be borne in mind that the invention in its broadest sense is not limited to GPS receivers, as mentioned above.

The GPS system currently uses a constellation of 24 orbiting satellites (SVs), each continuously broadcasting a respective navigation message. Generally, a GPS receiver receives signals from a plurality of these orbiting satellites and calculates its position from the received signals.

In more detail, each navigation message includes data sent at a rate of 50 bps, the data providing a time, an almanac and an ephemeris. The almanac includes course orbit and status information for each satellite in the constellation. The ephemeris includes data on the satellite's own precise orbit. A complete navigation message according to the GPS signal specification has a duration of 12.5 minutes, which is responsible for the long initial acquisition process when a receiver is first turned on. The almanac data assists in the acquisition of other satellites, while the ephemeris data from each satellite is needed to compute position fixes using the respective satellite.

Thus, each satellite in the GPS system continuously transmits a sequence of navigation messages, each navigation message lasting 12.5 minutes. Consecutive navigation messages from a particular satellite may be the same, or may include changes. For example, ephemeris data is typically updated every two hours and remains valid for four hours.

To transmit its navigation message, each GPS space vehicle transmits a navigational radio signal as two carrier frequencies, referenced as L1 and L2, at 1572.42 MHz and 1227.60 MHz respectively. These carrier signals are modulated by two digital code sequences (i.e. spread spectrum codes), a first of which is referred to as the course/acquisition code (CIA code) which is freely available to the public, and a second of which is referred to as the precise code (P code), which is usually encrypted and reserved for military applications.

The C/A code, typically used by commercial GPS receivers, modulates the L1 and the L2 carrier signals. Each space vehicle has its own unique C/A code, and that code is a 1023 chip pseudo-random (PRN) code at a rate of 1.023 million chips per second so that the C/A code of a particular space vehicle repeats in the broadcast navigation signal every millisecond. Thus, each satellite has its own C/A code so that signals from it can be uniquely identified and received separately from the other satellites transmitting on the same carrier frequency.

The C/A code sequences in the transmitted signals are synchronized to a common precise time reference, “the GPS time”, which is held by precise clocks on board each satellite and which are synchronized to a master clock.

Thus, a navigation signal transmitted from each SV typically includes L1 and L2 carrier frequencies modulated by the respective C/A code. The transmitted navigation signal from each satellite also includes the respective navigation message from that SV, this navigation message also known as the NAV code. This navigation message (which in general contains information on coordinates of the GPS satellites as a function of time, time information, clock corrections, atmospheric data, and other information) in certain arrangements is encoded in the transmitted signal by inverting the logical value of the C/A code whenever the navigation message bit is set to 1, and by leaving the logical value of the C/A code when a navigation message bit is set to 0. Thus, the actual navigation signal broadcast from a particular GPS SV can be generated by performing a modulo 2 addition of the respective navigation message (at 50 bps) and the respective C/A code (at just over 1 Mbps) and using the signal resulting from this addition to modulate the radio frequency carrier (L1 or L2).

In general, to calculate its position, a GPS receiver needs to receive navigation signals from four space vehicles (under certain special conditions three signals may be sufficient). To calculate its position, the receiver needs to know the time required for each of these navigation signals to reach the receiver from the respective SV (i.e. a time delay) and the receiver also needs to know the positions of those SVs. To determine the time delays, a GPS receiver knows the C/A codes used by each of the satellites, generates those C/A codes locally and uses correlation techniques. In other words, to determine the time delay from a particular SV, the receiver generates the C/A code of that SV, correlates that code with the received signal, and varies a time delay on the locally generated C/A code until peak correlation is achieved. Peak correlation occurs when the time delay of the locally generated C/A code equals the time of flight of the navigation message from that SV to the receiver.

In order to calculate the positions of the satellites from which the receiver is receiving signals, the receiver needs to extract data from the received navigation signals. Generally, the receiver does this by a combination of amplification and filtering of the received radio frequency signal, demodulation of the resultant signal to remove the L1 or L2 carrier frequency (this can also be referred to as carrier-stripping) to produce a carrier-stripped signal and then conversion of the carrier-stripped analog signal to digital data. It will be appreciated that the carrier-stripped signal comprises navigation message data from each of the space vehicles currently “in sight”, and the analog to digital conversion is performed at a sampling rate sufficiently high to preserve all of that data. The resultant digital data is then processed using digital signal processing means to extract the data from each respective navigation message. Again, this digital signal processing typically uses correlation techniques involving locally generated C/A codes to extract the respective 50 bps navigation message data from the digital signal resulting from the sampling of the carrier-stripped analogue signal.

The phase or mode of operation in which a GPS receiver tries to locate a sufficient number of satellite signals in order to calculate its position with sufficient accuracy (starting from scratch with little or no knowledge of the satellite's position) is usually called the “acquisition” phase. Once these satellite signals have been “found”, and an initial determination of position has been performed, then the GPS receiver can be regarded as operating in a “tracking” phase. In this tracking phase, the receiver system is essentially following changes or drift.

As mentioned above, a complete navigation message from a GPS satellite has a duration of 12.5 minutes and comprises 25 pages, each page having a duration of 30 seconds and comprising 5 sub frames, each sub frame having a duration of 6 seconds and comprising 10 data words, each data word having a duration of 0.6 seconds and comprising 30 data bits, each data bit having a duration of 0.02 seconds (i.e. 20 milliseconds, corresponding to the navigation message data rate of 50 bps). Current GPS receivers are arranged to read all of the data (i.e. extract all of the data of each navigation message) contained in the received signal during both acquisition and tracking modes. In other words, a conventional GPS receiver decodes all 25 pages of the 12.5 minute navigation message from each SV being tracked. While this is not a problem for devices such as in-car navigation systems incorporating GPS receivers, where power consumption is not a consideration, it does pose a problem (in other words a limiting factor) for handheld devices and other battery-powered devices incorporating GPS receivers (or other satellite system receivers) where battery life is of course limited.

### SUMMARY OF THE INVENTION

Embodiments of the present invention therefore provide a receiver and a method of operating a receiver for a global navigation satellite system that overcomes one or more of the problems associated with the prior art. Particular embodiments aim to provide a method of operating a global navigation satellite system receiver which reduces power consumption compared with prior art techniques. Further embodiments aim to provide a global navigation satellite system receiver operable in a manner that reduces power consumption. Embodiments of the present invention aim to provide receivers and methods of operation which reduce power consumption and prolong battery life.

According to a first aspect of the invention there is provided a method of operating a Global Navigation Satellite System (GNSS) receiver, the method includes receiving a plurality of navigation signals; operating the receiver in a first mode; operating the receiver in a second mode; wherein each of the first navigation signals is a signal transmitted from a respective space vehicle and includes a respective sequence of navigation messages, each navigation message includes data indicative of at least a position of the respective space vehicle; wherein the step of operating the receiver in the first mode includes extracting a first quantity of data from a first navigation message included in each of the first navigation signals by processing each of the first navigation messages; determining a position of the GNSS receiver using the first navigation signals using at least a portion of the extracted first quantities of data from each of the first navigation messages, and having determined position of the GNSS receiver, wherein the step of operating the receiver in a second mode includes continuing to receive a plurality of second navigation signals after receiving the first navigation messages; extracting a second quantity of data from the second navigation message included in each of the second navigation signals by processing each of the second navigation messages; and determining an updated position of the GNSS receiver using at least a portion of the extracted second quantities of data from each of the second navigation messages wherein a second quantity of data is less than the first quantity of data.

According to another aspect of the invention there is provided a Global Navigation Satellite System (GNSS) receiver, the GNSS receiver including a controller for controlling RF signal processing means and position determination means to operate in each of a first mode and a second mode; a receiver for receiving a plurality of first navigation signals and second navigation signals in the periods of time after receiving the first navigation signals; RF signal processing means for extracting a first quantity of data from a first navigation message and a second quantity of data from a second navigation message included in each of the first navigation signals and the second navigation signals by processing each of the first navigation messages and the second navigation messages; position determination means for determining a position of the GNSS receiver using the first navigation signals using at least a portion of the extracted first quantities of data from each of the first navigation messages, and determining an updated position of the receiver using at least a portion of the extracted second quantities of data from each of the second navigation messages; wherein each of the first navigation signals is a signal transmitted from a respective space vehicle and includes a respective sequence of navigation messages, each navigation message includes data indicative of at least a position of the respective space vehicle; wherein a second quantity of data is les than the first quantity of data.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating the structure of a navigation message in the GPS format;

FIG. 2 is a diagram illustrating the variation of the format of subframe 4 of a GPS navigation message as a function of page number throughout the 25 pages of a single navigation message;

FIG. 3 is a schematic diagram of a GPS receiver embodying the invention;

FIG. 4 is a representation of part of a navigation message illustrating the relationship between data in the message and a period of time selected by the control means of the receiver;

FIG. 5 is a schematic representation of some of the components of a GPS receiver in accordance with another embodiment of the invention; and

FIGS. 6A, 6B and 6C are schematic representations of three sequences of navigation messages, illustrating a selection of different portions of those messages in methods embodying the invention.

### DESCRIPTION OF EMBODIMENTS OF THE INVENTION

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

The following description of particular embodiments of the invention will concentrate particularly on GPS receivers and their operation. However, it will be appreciated that the present invention is not limited to GPS systems, and alternative embodiments provide receivers and methods of operation for other GNSSs.

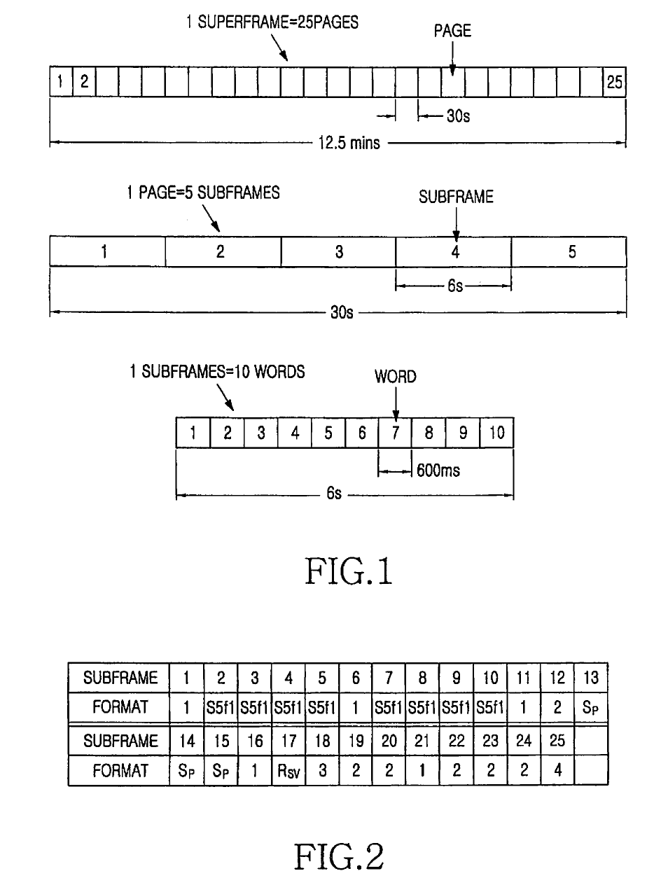

A conventional GPS receiver decodes 25 pages (known collectively as a superframe), each comprising 5 subframes of 300 bits each subframe, over a 12.5 minute period. In traditional implementations, the complete superframe is read during both acquisition and tracking modes, thus requiring that the GPS RF receiver and associated GPS baseband processing be active for the entire duration of the operation. In other words, conventional GPS receivers are arranged to extract all data from each navigation message from each of typically four SVs during acquisition and subsequent tracking modes. The superframe/subframe/word structure of a typical GPS navigation message is illustrated in FIG. 1.

FIG. 1 is a diagram illustrating the structure of a navigation message in the GPS format. Referring to FIG. 1, Subframes 1, 2 and 3 occur at the start of every page, with subframes 4 and 5 being subcommutated over the entire 25 pages of the superframe. Subframe 5 has two formats; format 1 is used for all the pages, apart from the final page (page 25), where format 2 is used. Subframe 4 is considerably more complex, having 6 different formats, and also using format 1 of subframe 5. In addition, the format of subframe 4 does not repeat in a periodic fashion within the superframe, but is mapped into it as shown in FIG. 2.

FIG. 2 is a diagram illustrating the variation of the format of subframe 4 of a GPS navigation message as a function of the page number throughout the 25 pages of a single navigation message. Referring to FIG. 2, certain embodiments of the invention utilize the fact that there is a degree of repetition of data within the superframe of a GPS navigation message (and others). For example, in certain embodiments the previous requirement to read all of the pages is removed.

In certain embodiments of the invention, once the signal from each SV has been acquired (and position has been determined (i.e. calculated) to within a predetermined accuracy), the reading frequency of the fine ephemeris data contained in subframes 1, 2 and 3 is reduced to a lower rate. This can be achieved by omitting certain subframes (i.e. not extracting data from those subframes). During the time of the omitted subframes, a GPS RF front-end of the receiver is put into a low-power mode, and woken up for the occurrence of the next required subftame. The time to wake-up from low-power mode in order to read the next required subframe can be determined from the timing information previously decoded from the navigation stream (i.e. the plurality of received navigation messages).

In the case where the navigation stream being read deteriorates to an unacceptable level such that decoding cannot be acceptably performed (position cannot be determined with sufficient accuracy, if at all) then the receiver, for example by operating according to a predetermined or pre-programmed algorithm, in certain embodiments is arranged to revert to its “first”, or normal power consumption mode of operation, in which the receiver attempts to extract all data from the incoming navigation messages, and begins to immediately read the next occurrence of subframes 1, 2 and 3 until new data is received and extracted which enables the normal decoding level required for navigation. Once this is achieved, operation in the second (reduced-power) mode (with subframe reading at reduced frequency) is re-established.

Control algorithms employed in certain embodiments of the invention include knowledge of the superframe structure in order to know when the GPS RF front-end can be safely put to “sleep” (i.e. into a low power mode of operation, or off altogether) without missing essential information elements. This is especially true for the monitoring of subframe 4, as the subframe reserved in page 17 for special messages and the format 3 subframe in page 18 only occur once per superframe.

Certain embodiments of the invention use of the following techniques to choose which subframes, or portions thereof, within each page to decode: a sliding window technique and a “sub-frame hopping” pattern.

The sliding window scheme may employ a sampling window across the periodic superframe, where the size of the window used is a modulo-1 factor of the entire superframe. This ensures that over time every message is read. A careful choosing of the window size can ensure that subframes that only occur once per superframe are never missed in the reading schedule.

The concept behind the “sub-frame hopping” technique is similar to that behind frequency-hopping in conventional radio communications, in which a hopping pattern is used which determines the next frequency to be used and is seeded from an initial point, usually a fixed time period. In certain embodiments of the invention, a hopping pattern is used which selects navigational data elements from each subframe. In this way, the validity period of each data element can be used to schedule the next time to read, by marking it appropriately in the hopping plan.

As can be seen from the complete 25-frame superframe, there is much spatially redundant information in the message, but its temporal position may be important, depending on the position of the SV. Use of the hopping technique ensures that any data missed may be accurately reconstructed by using the remaining navigation data that was last read.

The most important parts to be hopped (i.e. selectively ignored or not extracted) in certain embodiments are the almanac data contained in subframes 4 and 5, as that data is valid for a period of several weeks. Subframe 1 is read every time in certain embodiments (i.e. its data is extracted from each page of each navigation message), as it contains rapidly changing and vitally important parameters, such as clock correction.

A second-order polynomial may be used to implement the sliding-window technique in certain embodiments, while still allowing coverage of the unique blocks in subframe 4.

It will be appreciated that the power saving ability in certain embodiments of the invention is derived from the fact that the receiver utilizes software which is able to reduce the power consumption of the GPS RF front end by shutting down the receiver part of the device during reception of certain portions of data (data which is not required to be read, or extracted, in order to calculate a revised position). Other parts of the receiver device, such as clocks, may remain powered and running in order to provide timing signals and so enable the switching on of the receiver at the appropriate time.

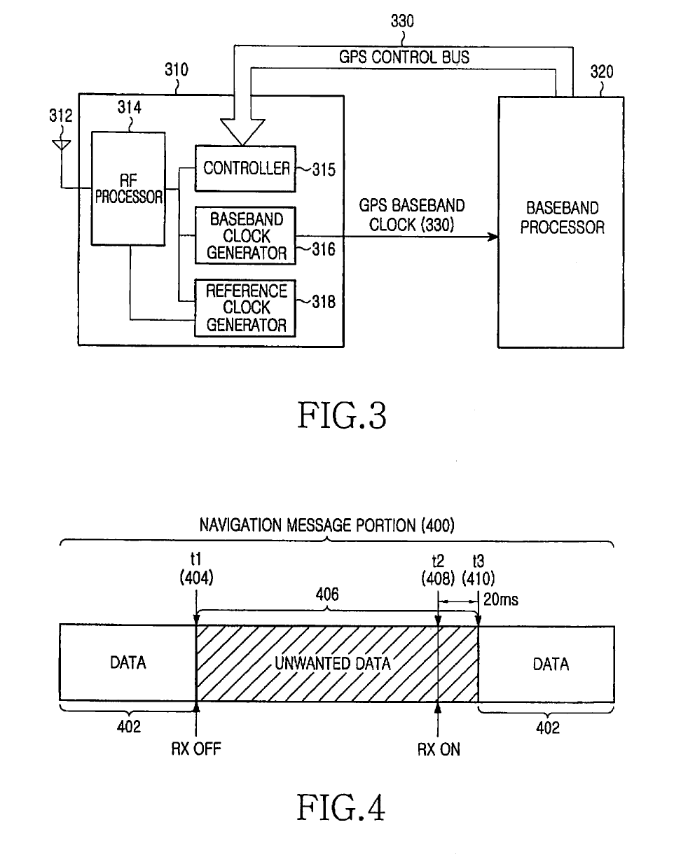

FIG. 3 is a schematic diagram of a GPS receiver embodying the invention. Referring to FIG. 3, the GPS receiver generally includes receiver 310 and base band processor or digital signal processor (DSP) 320, antenna 312, RF processor 314, controller 315, base band clock generator 316 and reference clock generator 318. The antenna 312 is arranged to receive radio frequency (RF) navigation signals from a plurality of satellites in the GPS constellation. The received RF signals are initially processed by the RF processor 314 (which may also be referred to as an RF front end, or RF processing stage). The reference clock generator 318 provides a reference clock signal to the RF front end 314, the base band clock generator 316 connected to the RF front end 314, the reference clock, and the controller 315, and adapted to provide a GPS base band clock signal 330 to the base band processor 320. The controller 315 is arranged to receive control signals via a control connection in the form of a GPS control bus 330 from the base band processor 320.

The receiver 310 is such that it processes the received RF signals and outputs a corresponding digital signal to the base band processor 320 which can then be processed by the base band processor 320 to extract the data from the separate navigation messages of the navigation signals received together at the antenna 312. In general terms, the base band processor 320 is programmed in accordance with knowledge of the format of GPS navigation messages and, once signals from a sufficient number of satellites have been acquired and the base band processor has determined the position of the receiver to a sufficient accuracy, the base band processor 320 is then able (by supplying appropriate control signals via the GPS control bus 330) to switch off or power down a selected portion or portions of the receiver 310 and so reduce power consumption while certain portions of incoming navigation messages are being received. In other words, the base band processor 320 has been programmed in such a way that it takes into account an inherent redundancy in the data structure of incoming navigation messages and also takes into account the position of the unused portions of the navigation message such that when certain portions of navigation messages are being received, data need not be extracted from them, and power consumption during these periods can thus be reduced.

A GPS superframe contains a large amount of bits in its structure that are at present unused, that is, they are reserved for future purposes, and bits that contain repeated informational elements. With regard to “unused” bits, certain embodiments of the invention are programmed with knowledge of the navigation message structure and hence the positions of these unused bits. The receivers are then adapted to synchronize with the received signals and then control the GPS RF front-end to operate in a low power mode during the time these “unused” bits are being transmitted. The receiver is then arranged to return the RF front-end to normal operation just before this period ends. In certain embodiments this “powering-down” of the RF front end includes switching off one or more parts (devices, circuits, stages, components etc.). Because parts of the GPS RF front-end are switched off in certain examples, there is a small amount of time required to return these parts of the device to their fully functional state. This is dealt with by re-activating those parts of the device a predetermined time interval (e.g. 20 milliseconds) before the data stream is required to be read again. This timing of switch-off and switch-on in relation to a portion of a navigation message to be “ignored” is shown in FIG. 4.

FIG. 4 is a representation of part of a navigation message illustrating the relationship between data in the message and a period of time selected by the control means of the receiver. Referring to FIG. 4, this shows a portion 400 of a navigation message which comprises data. During receipt of a first portion of data 402 the RF front end 314 the GPS receiver is controlled so as to be in a fully on state, such that all of that data 402 is extracted. Then, based on the knowledge of the incoming navigation message, and having already been synchronized with the incoming message, the base band processor 320 controls the RF front end to switch off at a time T1 404. The base band processor 320 has determined that a second portion of data 406 is unwanted (and is not needed to calculate an updated position of the receiver). The base band processor 320 is then arranged to return the RF front end 314 to its fully “on” state at a time T2 408, which in this example is 20 milliseconds before a time T3 410 which corresponds to the beginning of the next portion of data 402 to be read (i.e. processed, and its data extracted).

Clearly, the details of which portions of data may be ‘ignored’ in embodiments of the invention depends on the particular format of the incoming navigation messages, and hence base band processor 320 in receivers embodying invention should be programmed in accordance with knowledge of the format of the navigation messages of the particular system in which the receiver is to be used. With regard to GPS receivers, embodiments of the invention may be arranged to selectively omit one or more of the following areas of a GPS superframe, as at present they do not contain any useful navigation data.

TABLE 1
Subframe 1

| word | bits |
|---|---|
| 3 | 11-12 |
| 4 | 1-24 |
| 5 | 1-24 |
| 6 | 1-24 |
| 7 | 1-16 |

TABLE 2
Subframe 2

| word | bits |
|---|---|
| 10 | 17-22 |

TABLE 3

| pages | 1, 6, 11, 12, 16, 19, 20, 21, 22, 23 and 24 |
|---|---|
| bits | 69-300 |

Because the 6 parity bits per subframe only relate to that particular subframe, if all 24 preceding bits of a subframe are skipped, then the associated 6 bit parity field may also be omitted. However, if only part of the preceding 24 bits are skipped, then the parity part should be ignored, although this has the potential for corrupt navigation to be used, although analysis of where data is omitted in the frame cycle shows that the likelihood of this happening is extremely small.

With regard to potential power saving with embodiments of the invention, the following calculations are based upon skipping non-essential data from subframes 1 and subframe 4, format 1.

(90 bits skipped in subframe 1)+(232 bits skipped in subframe 4 format 1)=322 bits per page ((322 bits×25 pages)/37500 bits per superframe)×100=21.46%

Therefore this basic implementation would give a battery power saving of over 20%.

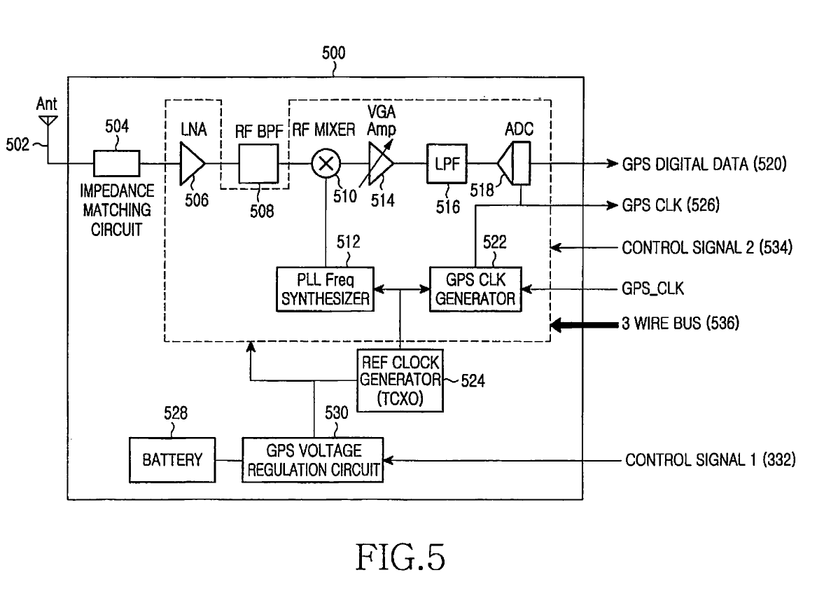

FIG. 5 is a schematic representation of some of the components of a GPS receiver in accordance with another embodiment of the invention. Referring to FIG. 5, the GPS receiver 500 includes antenna 502, impedance matching circuit 504, Low Noise Amplifier (LNA) 506, RF Band Pass Filter (BPF) 508, RF mixer 510, Phase Locked Loop (PLL) frequency synthesiser circuit 512, Variable Gain Amplifier (VGA) 514, Low Pass (LP) filter 516, and Analog to Digital Converter (ADC) 518.

The antenna 502 is connected to impedance matching circuit 504. Via this impedance matching circuit 504, the antenna 502 passes the combination of received navigation RF signals to LNA 506. The amplified signal from LNA 506 is then filtered by RF BPF 508, and the filtered signal is provided to RF mixer 510. The RF mixer 510 is arranged to received a Local Oscillator (LO) signal from PLL frequency synthesiser circuit 512 which synthesizes the LO oscillating signal from an accurate reference clock signal from a reference clock generator 524. The output from the RF mixer 510 is essentially a carrier-stripped signal. Although it should be kept in mind that this signal still includes a mixture of incoming navigation messages, as in this embodiment those signals are processed initially in parallel; this is possible because the different satellites of the GPS system have modulated the carrier signals using CDMA techniques. The carrier-stripped signal is then amplified by VGA 514 and the amplified signal is then filtered by LP filter 516 before being supplied to ADC 518. ADC 518 is arranged to sample the signal from the LPF 516 at a sampling rate which is sufficiently high to preserve essentially all of the data from all of the component navigation messages. In other words, the GPS digital data 520 output from the ADC 518 does not simply correspond to a single one of the incoming navigation messages, instead it includes data from a plurality of incoming messages and the data from the individual messages can then be extracted by appropriate subsequent processing (e.g. using correlation techniques). This subsequent processing is performed by a processor or DSP which is part of the receiver, not shown in FIG. 5.

The GPS receiver 500 also includes a GPS clock generator 522, which receives the reference clock signal from the reference clock generator 524. The GPS clock generator 522 provides a GPS clock signal 526 to the ADC 518 and also outputs the signal (for example for use by the DSP). The receiver 500 also includes a battery 528 which supplies the power to operate the various receiver components. The battery 528 supplies this power via a GPS voltage regulation circuit 530, which itself is arranged to be controlled by control signal 1 332 (GPS_EN) from a suitable control means (e.g. the DSP).

In use, and after the GPS receiver 500 has acquired the satellite navigation signals and has determined its position, the control means of the receiver is arranged to control the GPS receiver 500 to operate in a power save mode during receipt of certain portions of the incoming navigation messages. In power save mode, the LNA 506, the RF mixer 510, the PLL frequency synthesizer 512, the VGA amplifier 514, and the ADC 518 are switched off (by means of a control signal 2 534 from the GPS receiver's control means (the control means is not illustrated in FIG. 5).

This control signal 2 534 may, for example, be a signal on a GPS_RX_EN control line, or may be a control signal supplied via a control bus such as the 3 wire bus 536. Although the above mentioned components, stages or circuits are switched off in the power save mode, the GPS voltage regulator 530, the reference clock 524 and the GPS clock generator 522 are arranged to remain on in this embodiment for fast recovery, in other words, to enable the signal processing means of the receiver to rapidly resume proper operation at the end of the period of operation in power save mode.

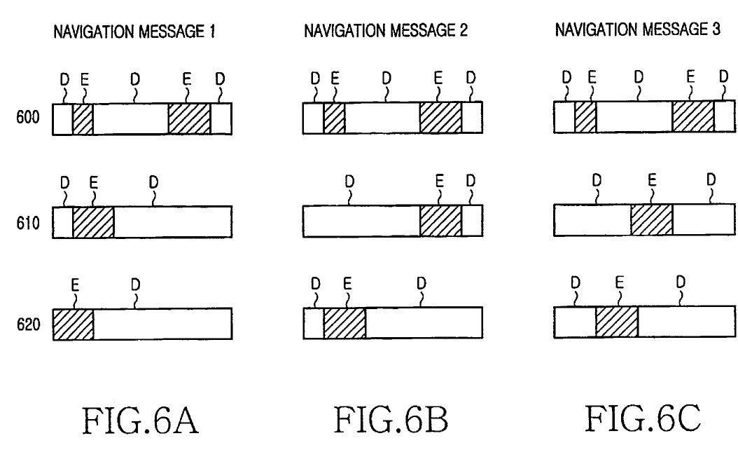

Referring now to FIGS. 6A, 6B and 6C, these show three sequences: sequence 1 600, sequence 2 610, and sequence 3 620, each of navigation message 1, 2 and 3. Each sequence includes three separate navigation messages shown respectively in FIGS. 6A, 6B, and 6C. The messages and selected data portions thereof are shown in schematic and simplified form but generally indicate different time period selections employed in different embodiments of the invention. For sequence 1 600 the control means of the receiver has been arranged to ‘ignore’ the same portions of unwanted data E in each of the three messages shown in FIGS. 6A, 6B and 6C. In other words, the control means of the receiver has been arranged to switch off or at least power down at least one of the active signal processing means so that the same pieces of data in each of the three messages shown in FIGS. 6A, 6B and 6C is ignored (i.e. is not extracted).

Sequence 2 610 shows an alternative technique in which the control means of the receiver has selected different portions E of data to ignore in each of the sequence of three messages. Thus, the positions of the data being extracted, and the positions of the data not being extracted (i.e. being ignored) vary from message to message.

In sequence 3 620 the receiver has been arranged to implement a ‘sliding window’ technique of data extraction in which the position of the portion of data E not being extracted changes from one message to the next in a predetermined manner.

It will be appreciated that a receiver as shown in FIG. 5 may also be used to implement a method as defined in the claims. To do so, the control means need not power down the various front end components during tracking mode (although it could do so, to save even more power), but the DSP is arranged to perform a reduced quantity of processing in the second, tracking mode to arrive at an updated position. It will also be appreciated that, while calculating updated position using a reduced number of processing operations, the DSP in certain embodiments may use the “saved” processing capacity for some other processing function.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of operating a Global Navigation Satellite System (GNSS) receiver, the method comprising the steps of:
receiving a plurality of first navigation signals, each of the first navigation signals is a signal transmitted from a respective space vehicle and includes a respective sequence of navigation messages, each navigation message includes data indicative of at least a position of the respective space vehicle;
operating the receiver in a first mode, comprising:
extracting a first quantity of data from a first navigation message included in each of the first navigation signals by processing each of the first navigation messages; and
determining a position of the GNSS receiver using the first navigation signals using at least a portion of the first quantities of data from each of the first navigation messages; and
operating the receiver in a second mode, after having determined position of the GNSS receiver, comprising:
receiving a plurality of second navigation signals after receiving the first navigation messages;
extracting a second quantity of data from second navigation messages included in each of the second navigation signals by processing each of the second navigation messages, the second quantity of data is less than the first quantity of data; and
determining an updated position of the GNSS receiver using at least a portion of the second quantities of data from each of the second navigation messages.

2. A Global Navigation Satellite System (GNSS) receiver, comprising:
a controller for controlling RF signal processing means and position determination means to operate in each of a first mode and a second mode;
a receiver for receiving a plurality of first navigation signals, transmitted from a respective space vehicle and including a respective sequence of navigation messages, each navigation message including data indicative of at least a position of the respective space vehicle, and for receiving a plurality of second navigation signals after receiving the first navigation signals;
RF signal processing means for extracting a first quantity of data from a first navigation message and a second quantity of data less than the first quantity of data, from a second navigation message included in each of the first navigation signals and the second navigation signals by processing each of the first navigation messages and the second navigation messages; and
position determination means for determining a position of the GNSS receiver using at least a portion of the first quantities of data from each of the first navigation messages, and determining an updated position of the receiver using at least a portion of the second quantities of data from each of the second navigation messages.

3. The receiver of claim 2, wherein the receiver is contained within a mobile device or portable equipment.

4. The receiver of claim 2, wherein the first navigation signals and the second navigation signals are Radio Frequency (RF) signals,
wherein the RF signal processing means is operated in a first power consumption mode to extract the first quantity of data and operated in a second power consumption mode to extract the second first quantity of data, and
wherein the average power consumed by the RF signal processing means over a period corresponding to the duration of a navigation message is less in the second power consumption mode than in the first power consumption mode.

5. The receiver of claim 2, wherein the RF signal processing means is operated in the second power consumption mode or at least one signal processing component of the RF signal processing means is operated in a reduced power consumption mode for at least one selected period of time.

6. The receiver of claim 4, wherein at least one active RF signal processing means is operated at the first power consumption mode and the at least one active RF signal processing means are switched off or operated at a reduced power level for at least one selected period of time to extract the second quantity of data so as not to extract data from a portion of a navigation message of the at least one navigation signal received during each selected period of time.

7. The receiver of claim 6, wherein at least one common active RF signal processing means are arranged to process a combination of the first navigation signals and switched off or operated at a reduced power level for the at least one selected period of time to extract the second quantity of data so as not to extract data from a portion of a navigation message of each of the combination of navigation signals received during each selected period of time.

8. The receiver of claim 6, wherein a plurality of active signal processing means arranged in series processes at least one of the first navigation signals and is switched off or operated at reduced power level during each selected period of time to extract a second quantity of data.

9. The receiver of claim 6, wherein the at least one active RF signal processing means includes an amplifier operable to amplify at least one of the first and the second navigation signals, or a processed signal derived from at least one of the first navigation signals and the second navigation signals,
wherein the amplifier is switched off or operated at reduced power level to extract the second quantity of data so as not to amplify the at least one of the first navigation signals and the second navigation signals, or a processed signal derived from at least one of the first navigation signals and the second navigation signals.

10. The receiver of claim 6, wherein the at least one active signal processing means includes a mixer circuit arranged to receive an oscillating signal from a local oscillator,
wherein the at least one active RF signal processing means extracts a carrier frequency from at least one of the first navigation signals or a processed signal derived from at least one of the first navigation signals to extract the first quantity of data, and
wherein the at least one active RF signal processing means extracts a carrier frequency from at least one of the second navigation signals or a processed signal derived from at least one of the second navigation signals to extract the second quantity of data.

11. The receiver of claim 10, wherein the mixer circuit is switched off or operated at reduced power level during each selected period of time to extract the second quantity of data.

12. The receiver of claims 11, wherein the local oscillator is switched off during each selected period of time to extract the second quantity of data.

13. The receiver of claim 7, wherein the at least one active RF signal processing means comprises an Analogue to Digital Converter (ADC) operable to sample at least one of the first navigation signals and the second navigation signals, or a processed signal derived from at least one of the first navigation signals and the second navigation signals, and generate a digital signal corresponding to the sampling result, and
wherein the ADC is switched off or operated at reduced power level so as not to generate the digital signal during each selected period of time to extract the second quantity of data.

14. The receiver of claim 13, wherein the at least one active RF signal processing means comprises digital signal processing means arranged to process the digital signal,
wherein the controller controls the digital signal processing means so as not to process the digital signal during each selected period of time to extract the second quantity of data to extract the second quantity of data.

15. The receiver of claim 14, wherein the at least one active RF signal processing means comprises an Analogue to Digital Converter (ADC) operable to sample at least one of the first navigation signals and the second navigation signals, or a processed signal derived from at least one of the first navigation signals and the second navigation signals and generate a digital signal corresponding to the sampling result, and
wherein a sampling rate of the ADC is reduced during each selected period of time to extract the second quantity of data.

16. The receiver of claim 15, wherein the at least one active signal processing means comprises digital signal processing means arranged to process the digital signal, ad
wherein a processing rate of the digital signal processing means is reduced during each selected period of time to extract the second quantity of data.

17. The receiver of claim 4, wherein the controller synchronises the GNSS receiver with the first navigation signals and the second navigation signals, and selects each period of time correspond to a respective portion of a navigation message of at least one of the first navigation signals and the second navigation signals.

18. The receiver of claim 17, wherein the controller selects each periods of time to end a predetermined time interval before a respective portion of the first navigation signal from which the first quantity of data is to be extracted and a respective portion of the second navigation signal from which the second quantity of data is to be extracted.

19. The receiver of claim 17, wherein the controller is switched on or initiates a resumption to the first power consumption level one of the at least one active signal processing means at the end of the each period of time.

20. The receiver of claim 17, wherein the controller selects the periods of time to correspond to the same portion or portions of each navigation message of a sequence of first navigation messages or second navigation messages of at least one of the first navigation signals and the second navigation signals.

21. The receiver of claim 17, wherein the controller selects the periods of time to correspond to a different portion or portions of each navigation message of a sequence of first navigation messages or second navigation messages of at least one of the first navigation signals and the second navigation signals.

22. The receiver of claim 2, wherein the GNSS receiver is switched from an operation in the second mode to an operation in the first mode when the precision of the updated position of the GNSS receiver in the second mode falls below a predetermined threshold.
